(19) United States
(12) Patent Application Publication
(10) Pub. No.: US 2024/0188759 A1
(43) Pub. Date: Jun. 13, 2024

(54) INSERT MODULE FOR A POT OF A KITCHEN APPLIANCE

(71) Applicant: WUNDERMIX GMBH, Garching b. München (DE)

(72) Inventor: Adrian KEUSGEN, Endingen am Kaiserstuhl (DE)

(21) Appl. No.: 18/554,348

(22) PCT Filed: Jul. 26, 2022
(86) PCT No.: PCT/EP2022/070994

§ 371 Date: Oct. 6, 2023

(30) Foreign Application Priority Data
Jul. 28, 2021 (DE) 10 2021 119 670.1
Dec. 1, 2021 (DE) 10 2021 131 680.4

(51) Int. Cl. A47J 43/07; A47J 36/16; A47J 43/046

(52) U.S. Cl. CPC A47J 43/0727; A47J 36/16; A47J 43/046

(57) ABSTRACT

An insert module for a pot of a kitchen appliance includes a disk-shaped base component, wherein an external diameter of the base component is matched to an internal diameter of the pot. The internal diameter decreases toward the pot base of the pot, such that the insert module rests inside the pot, spaced apart from the pot base at a working height, against an internal wall of the pot. An outer contour of the base element is matched to an inner contour of the internal wall at the working height. The insert module is configured to delimit a useful space within the pot in an upward direction when it is inserted into the pot.

### CROSS-REFERENCE TO RELATED APPLICATIONS

This application is a 35 U.S.C. § 371 National Stage patent application of PCT/EP2022/070994, filed on 26 Jul. 2022, which claims the benefit of German patent application 10 2021 119 670.1, filed on 28 Jul. 2021 and German patent application 10 2021 131 680.4, filed on 1 Dec. 2021, the contents of which are incorporated herein by reference in their entirety.

### TECHNICAL FIELD

The present disclosure relates to an insert module for a pot of a kitchen appliance. Furthermore, the present disclosure relates to a kitchen appliance having such an insert module and to a set composed of such an insert module and a pot for a kitchen appliance.

### BACKGROUND

Electric kitchen appliances are known which comprise a pot in which a useful space is formed. This useful space is designed to accommodate and process a product to be processed, for example chocolate, nuts, hard cheese, cereals, powdered sugar, spices, oil, eggs, herbs or the like. A functional element, for example cutting means or mixing knives, can be arranged in the useful space. Such a pot can have an opening in its base region through which the functional element extends. The pot can be inserted into the kitchen appliance from above and then surrounds the functional element, which is driven by a drive unit of the kitchen appliance. For example, such a kitchen appliance comprising such a pot is marketed under the name Thermomix® multicooker.

It has been found to be a disadvantage that the product to be processed does not remain permanently in the base region of the pot, but moves upwards in the pot during processing. This disadvantage occurs in particular during processing operations in which there is only a relatively small amount of the product to be processed in the pot compared to the dimensions of the pot. The upwardly moved product is then no longer picked up by the functional element and thus no longer processed as desired. This has a negative effect on the result of the processing operation since the product to be processed can no longer be processed uniformly. This leads to the fact that the processing operation must be repeatedly interrupted and the upwardly moved product must be moved back by a user in the direction of the functional element.

As an alternative to interrupting the processing operation, means can be provided which automatically move the upwardly moved product downwards during the processing operation. However, the specific design of such means will depend on the particular product to be processed. For example, a powdery product will have to be handled differently from a paste-like product. This leads to the fact that such means must be adapted to the product to be processed. As a result, a user not only has to keep a larger number of different means on hand, but the user also has to select the correct one from the available means in each case. Furthermore, this results in substantial additional costs.

### SUMMARY

The present disclosure provides means which are as universally applicable as possible and as inexpensive as possible and with which a result of certain preparation processes of a kitchen appliance can be improved.

This is achieved in each case by providing the combinations of features of the independent claims.

Further configurations and refinements of the disclosure are disclosed in the respective subclaims.

It should be noted that the features listed individually in the claims can be combined with one another in any technically useful manner and reveal further configurations of the disclosure. The description additionally characterizes and specifies the disclosure, in particular in connection with the figures.

It should further be noted that a conjunction “and/or” as used herein which stands between two features and links them together is always to be interpreted such that in a first configuration of the described subject matter only the first feature may be present, in a second embodiment only the second feature may be present, and in a third embodiment both the first and second features may be present.

It has been recognized that in order to improve the preparation result, it is not absolutely necessary to repeatedly return upwardly moving material towards the functional element. Rather, by providing an insert module for the pot of the kitchen appliance, the useful space can be limited, which can reduce upward movement of a product to be processed and reliably hold the product to be processed at the functional element.

Such an insert module has a disk-shaped base component. This base component is dimensionally adapted to a pot into which it is to be inserted from above. Since the kitchen appliances in question can usually be operated with only one or at most a few different pots, such an adaptation is easy to implement. For this purpose, an outer diameter of the base component is adapted to an inner diameter of the pot which decreases towards the pot base of the pot. As a result, an insert module inserted into the pot is in contact with the internal wall of the pot at a working height. In addition to the adaptation of the outer diameter, the base component is adapted in its outer contour, namely to an inner contour of the internal wall of the pot at the working height. The result of this is that in an inserted state, the insert module delimits a useful space, which is formed at a pot base of the pot within a pot, towards the top. This reduces a useful space available for a product to be processed during the processing operation. This, in turn, results in the fact that an improved preparation result can be achieved even during processing operations with a relatively small amount of the product to be processed. In this manner, the insert module creates a useful space in the interior of the pot in which a functional element can be arranged, and a second space arranged above it. If necessary, the second space can also be used, for example for keeping food warm.

The insert module thus acts as a volume-reducing module and can be produced cost-effectively using the injection molding process. In addition, the handling thereof is particularly easy because it can be designed as a single coherent component.

The working height can be relatively freely defined. In principle, it is irrelevant from which reference point the working height is measured. In one configuration, the working height is measured by the distance that the insert module has from a pot base in an inserted state. In this case, the working height can be measured to a base component surface that faces the pot base in an inserted state.

The working height should be at most so small that a functional element located in the useful space can be operated without interference from the insert module. In particular, this can mean that the insert module does not come into direct contact with the functional element during operation of the functional element. Furthermore, the working height should not be too high, otherwise the function of the insert module will be reduced. In one configuration, the working height is less than or equal to 60% of the height of the pot, and in another configuration, it is less than or equal to 50% of the height of the pot.

In principle, an adaptation of the outer contour to an inner contour can be pronounced differently. Thus, it is conceivable that in an inserted state, the outer contour contacts the internal wall only at a few dedicated points. In a preferred configuration, however, the outer contour is adapted to the inner contour in such a manner that the insert module not only delimits the useful space but also closes it off. This means that in an inserted state, the base component rests against the internal wall of the pot not only in point contact, but along a line. This can go as far as a liquid-tight and/or dust-tight closure.

An adaptation of the outer contour can also comprise that the outer contour is contoured in a side view. This can be implemented by a rounded edge of the base component, allowing the outer contour to reliably contact the internal wall even when the insert module is not ideally inserted. However, the outer contour can also be beveled. In this case, it makes sense that the inclination of the outer contour is approximately the same as the inclination of the internal wall at the working height. This brief and non-exhaustive list shows how the outer contour can be adapted to an inner contour.

With regard to adapting the outer diameter of the base component to the inner diameter of the internal wall, it should also be noted that although the use of a substantially circular outer contour of the base component or a substantially circular inner contour of the internal wall is a preferred exemplary embodiment, the contours do not necessarily have to be circular. Other contours are also conceivable in principle. At the same time, projections and/or recesses can be provided in the contours. In this respect, the terms “inner diameter” and “outer diameter” are not to be understood as a mandatory restriction to a circular configuration.

The term “disk-shaped base component” refers generally to a substantially flat base component. In one embodiment, the disk-shaped base component is formed as a circular ring in a plan view. However, this does not mean that the base component must only be flat in shape. For example, shaped portions, connecting elements and/or webs can be formed on the base component which project from a plane of the base component.

The “inserted state” is considered to be the state in which the insert module is in an intended positioning in the pot of the kitchen appliance. This means that the insert module is positioned at the working height and in a predefined orientation within the pot. In particular, in the case of non-rotationally symmetrical internal contours, this can include a suitable rotation of the base component about an axis perpendicular to the base component. At the same time, this can mean that this axis is in a desired orientation with respect to the pot, for example perpendicular to the pot base.

The insert module can be made of a wide variety of materials. In particular, materials that are both robust and easy to process are suitable. In one configuration, the insert module is formed from a plastic material. In another embodiment, the insert module is made of a metal, for example aluminum or stainless steel.

The insert module can be adapted for a wide variety of pots from a wide variety of kitchen appliances. Preferably, however, the insert module is adapted to a Thermomix® multicooker, for example a Thermomix® multicooker TM6, TM5 and/or TM31.

In one configuration, the insert module additionally has a connecting means which, in an inserted state, is designed to delimit a third space from a second space formed between the base component and the internal wall, wherein the connecting means is preferably arranged perpendicular to the disk-shaped base component and/or is designed as a hollow cylinder. By delimiting a third space, on the one hand, the second space can be further divided. On the other hand, the third space can fulfill further functions, for example as a region which can be used for filling in products to be processed. Moreover, in an inserted state, the connecting means can rest against a part of the pot, whereby the seat of the insert module in the pot can be further stabilized and an axial mounting of the insert module in the pot can be achieved. In one configuration, the connecting module can extend from an upper side of the insert module facing a lid of the pot or the opening of the pot substantially vertically upwards towards the lid and contact the lid in the state when the pot is closed with the lid.

In one configuration, a base component opening is formed in the base component, wherein the base component opening is preferably arranged on a central axis through a center of the base component. In this manner, access to the useful space can be provided, for example, to introduce a product to be processed into the useful space, even when the insert module is inserted into the pot. An arrangement on a central axis can facilitate a simple production of the insert module.

In one refinement, the connecting means and the base component opening are arranged relative to each other such that the base component opening forms a connection between the useful space and the third space. In this manner, the connecting means can cooperate with an insertion of the product to be processed, since the product can be brought to the bottom element opening in a particularly simple manner. In this case, a longitudinal axis of the connecting means, for example a hollow cylinder axis, can pass through a center of the base component opening.

In one configuration, the base component has a shaped portion, wherein the shaped portion is preferably cone-shaped and/or funnel-shaped and/or, in an inserted state, is preferably directed towards the useful space. Such a shaped portion can further reduce the useful space in a favorable manner. The shaped portion can extend close to the functional element, for example with a spacing of a few millimeters, whereby the product to be processed can be better guided to the functional element. A cone-shaped configuration offers the advantage that the product to be processed can be better detached from the insert module by gravity. A funnel-shaped configuration is particularly helpful when using a base component opening, wherein the base component opening can then be arranged at the outlet of the funnel.

In one configuration, at least one recess is formed on the outer contour of the base component, wherein the at least one recess is preferably designed to engage, in the inserted state, in a projection, preferably a bead, rib or ridge, formed on the internal wall of the pot. Such projections, ribs, ridges or beads are commonly used to stabilize pots. If, for example, the internal wall of the pot has vertically extending projections, as is the case with the Thermomix® multicooker, the base component can have corresponding recesses or notches in its outer contour which are adapted to the shape of the projections. In an inserted state of the insert module, the projections are located in the recesses and prevent the insert module from rotating or twisting. Thus, the insert module is radially mounted.

In one configuration, at least one web is formed on the outer contour, wherein the at least one web protrudes from the disk-shaped base component such that in an inserted state, an outer edge of the web rests against the internal wall of the pot. Such webs can further stabilize the position and/or orientation of the insert module. Such a web can be made of the same material as the insert module itself. In this case, the at least one web can be formed integrally with the insert module. However, such a web can also be formed from another material, for example a softer plastic material or rubber. This configuration improves a contact between the insert module and the internal wall of the pot.

In one refinement, the at least one web is arranged at at least one recess/one of the at least one recess. Such an arrangement can facilitate the stability of the webs. Furthermore, in an inserted state, the web can then rest against an projection on the internal wall of the pot, which in turn can improve the stability of the mounting.

In one refinement, the at least one web is at least partially lip-shaped and/or designed to seal the useful space. In the inserted state of the insert module, lip-shaped webs provide a relatively large contact surface to the internal wall of the pot, due to their typically high or increased flexibility. Such webs can additionally seal the useful space, whereby liquids can also be reliably processed and held in the useful space.

In one configuration of the kitchen appliance, a functional element, which is designed for processing products located in the useful space, is arranged or can be arranged in the useful space and can preferably be driven by a drive unit of the kitchen appliance. In this manner, the insert module can act in a particularly favorable manner. Such a functional element can be formed, for example, as cutting means or mixing knives.

In one configuration, the kitchen appliance comprises a lid which closes off the interior of the pot and the insert module comprises a connecting means, wherein the connecting means is preferably adapted to the lid and/or to the relative arrangement of the insert module to the lid such that the connecting means is supported on the lid. In this manner, the connecting means can provide and/or facilitate axial mounting of the insert module in the pot. If a lid opening is formed on the lid, this lid opening can be arranged at the upper end of the connecting element. Together with a base component opening, a channel can thus be created from the lid opening via the interior of the connecting element and the base element opening into the useful space. Thus, the product to be processed can be introduced into the useful space during operation of the kitchen appliance.

In one refinement, a protrusion is formed on the lid and the connecting element engages with the protrusion or the protrusion engages with the connecting element. This protrusion can point in the direction of the interior of the pot. In this case, the length of the connecting element can be selected such that its upper free edge rests against an underside of the lid. The diameter of the connecting element can be selected such that in an assembled state, the protrusion engages in the connecting element. In this manner, a mounting can be created in a horizontal direction.

In one configuration, the insert module is arranged substantially parallel to the pot base in the inserted state. This results in a defined positioning of the insert module in the pot.

### BRIEF DESCRIPTION OF THE DRAWINGS

Further features and advantages of the disclosure are apparent from the following description of non-limiting exemplary embodiments of the disclosure, which will be explained in more detail below with reference to the drawing. In this drawing, schematically:

FIG. 1 shows an oblique view of a set including an insert module according to the present disclosure and a pot for a kitchen appliance in an exploded view,

FIG. 2 shows a sectional view of the set according to FIG. 1 with an insert module in an inserted state,

FIG. 3 shows an oblique view of an insert module according to the present disclosure from above,

FIG. 4 shows an oblique view of the insert module according to FIG. 3 from below, and

FIG. 5 shows a side view of the insert module according to FIG. 3.

### DETAILED DESCRIPTION OF THE DRAWINGS

In the different figures, parts that are equivalent with respect to their function are always provided with the same reference signs, so that they are generally described only once.

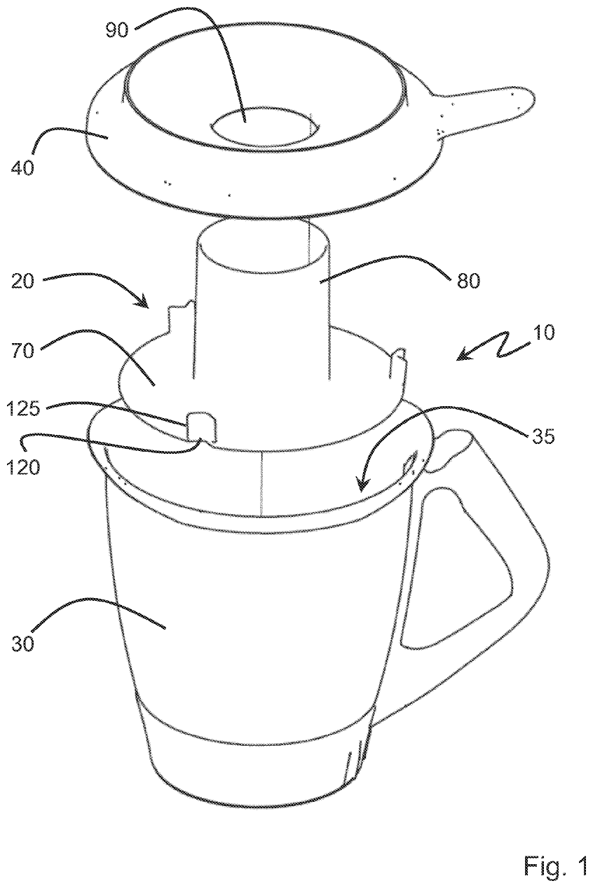

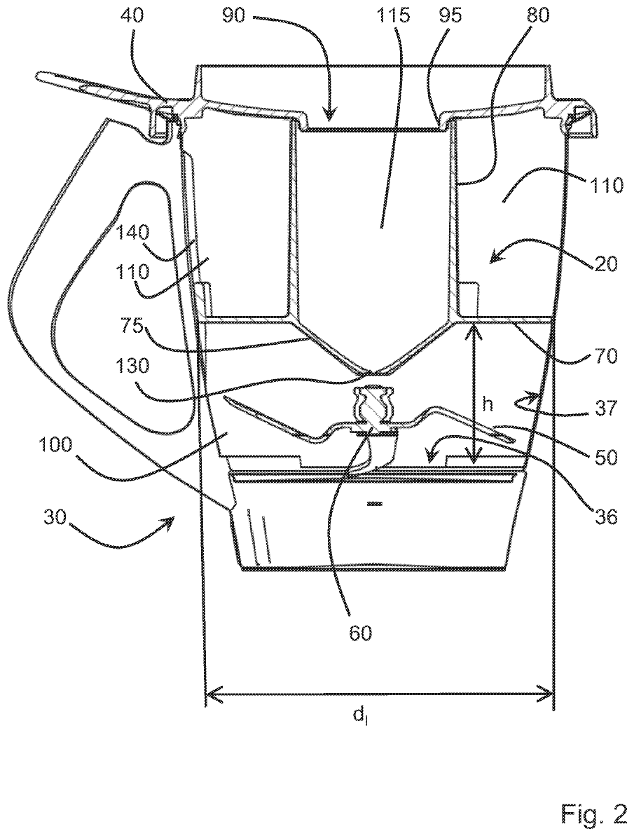

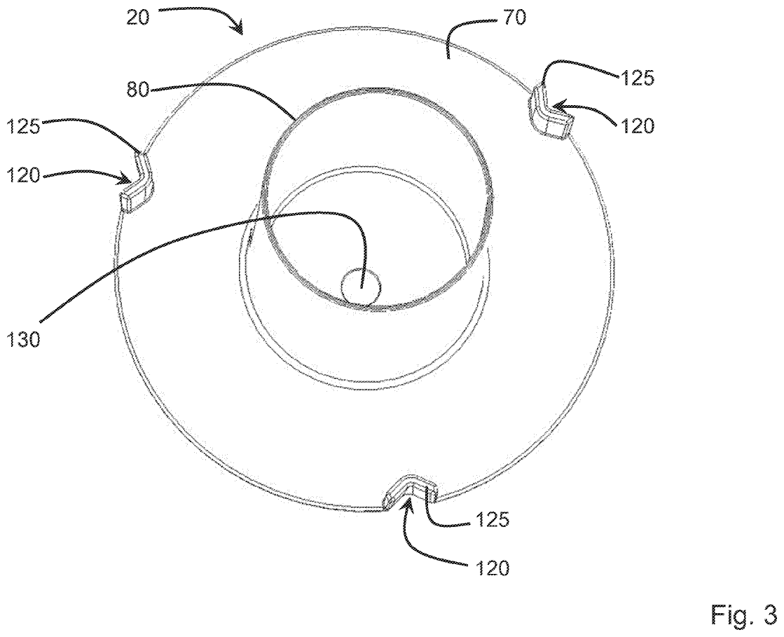

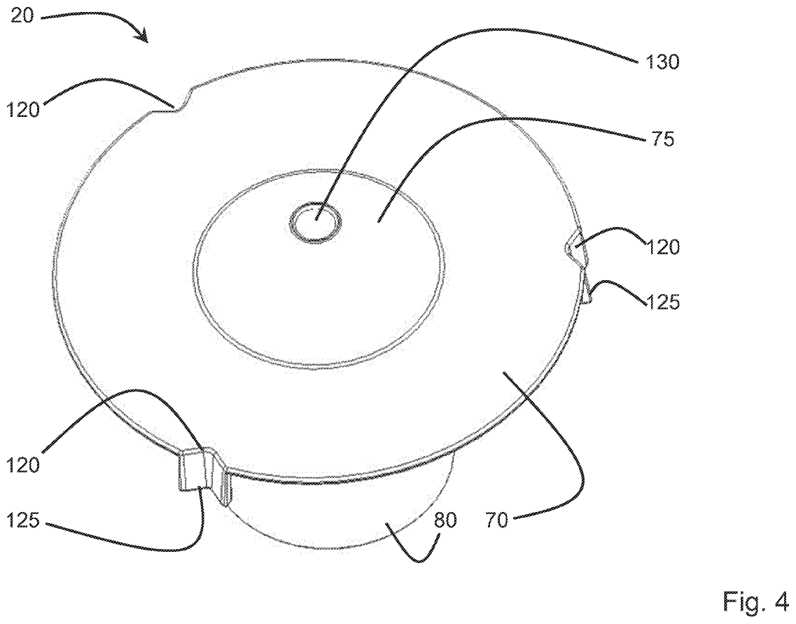

FIGS. 1 and 2 show different views of a set 10 composed of an insert module 20 according to the present disclosure and a pot 30 for a kitchen appliance (not shown), wherein FIG. 1 shows the set 10 in an exploded view and FIG. 2 in a sectional view. Shown is a pot 30 marketed under the name Thermomix® multicooker. FIGS. 3 to 5 show different views of the insert module 20, namely in perspective illustration from above, from below and from the side. FIG. 1 illustrates that the insert module 20 is insertable into an interior 35 of the pot 30, wherein the pot 30 further comprises a lid 40. FIG. 2 shows the assembled state of the pot 30 including the insert module 20 and the lid 40.

An outer diameter da of the base component 70 is adapted to an inner diameter di of the pot 30. In FIG. 2, it can be seen that the inner diameter decreases progressively towards the pot base 36 of the pot. As a result, the insert module 20 comes to rest at a working height h which in the illustrated exemplary embodiment is defined as the distance between a lower surface of the base component 70 and the pot base 36. To define the working height, the outer diameter da should correspond to the inner diameter di at the working height h.

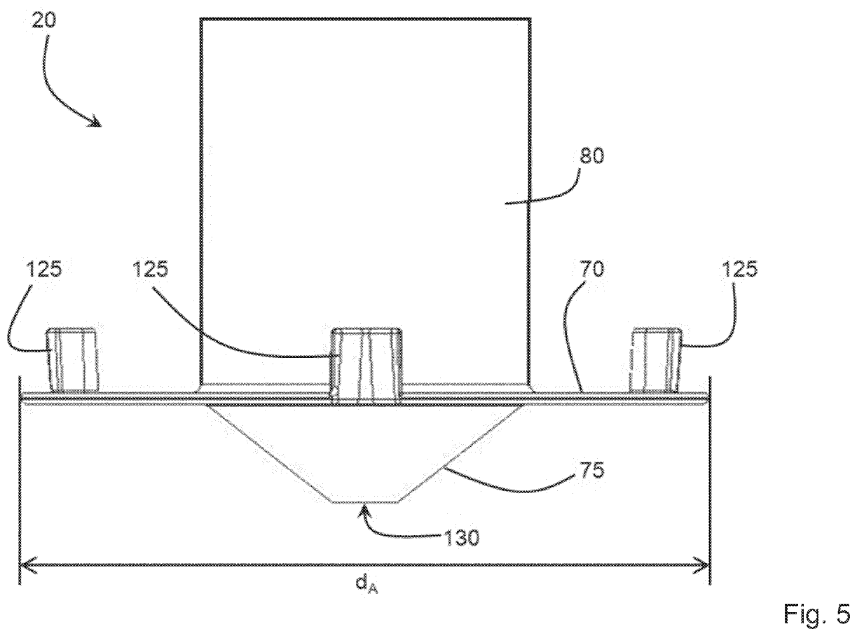

In addition to the adaptation of the diameters da, di, an outer contour of the base component 70 is adapted to an inner contour of the pot at the working height h, whereby the insert module 20 rests against an internal wall 37 of the pot along a line. In FIG. 5, it can be seen that the outer contour is contoured, namely rounded, in a side view. This improves the contact of the base component 70 with the internal wall 37.

In the assembled state, a functional element 50, mixing knives in the example shown, is located below the insert module 20. The mixing knives are driven by a drive unit (not shown) of the kitchen appliance (also not shown) via a drive shaft 60.

The insert module 20 has a disk-shaped base component 70. In the exemplary embodiment shown, a connecting element 80 extends vertically upwards from the base component 70 in the direction of the cover 40 and contacts it. In this case, the connecting element 80 is formed as a hollow cylinder. The length of the connecting element 80 is selected such that its upper free edge rests against a lower side of the lid 40. As a result, the insert module 20 is mounted in the axial direction.

The lid has a lid opening 90 which is surrounded by a protrusion 95. The protrusion 95 faces towards the interior 35 of the pot 30. In the inserted state of the insert module 20, the protrusion 95 extends into an upper hollow cylinder opening of the connecting element 80. The protrusion 95 acts as an abutment in all horizontal directions for the insert module 20.

The base component 70 divides the interior 35 of the pot 30 into a useful space 100 and a second space 110. The connecting element 80 also delimits a third space 115 with respect to the second space 110.

The base component 20 has a base component opening 130 that connects the useful space 100 to the interior of the connecting element 80—third space 115—located thereabove. Below the connecting element 80, a shaped portion 75 is formed on the base component 70 that is funnel-shaped and extends towards the functional element 50. At the tip of the shaped portion 75, the base component opening 130 is arranged. In an assembled state, a connection to the useful space 100 is created through the lid opening 90, the connecting element 80 and the base component opening 130. This connection can be used in both directions, for example in the direction of the useful space 100 for introducing the product to be processed, and in the direction of the lid opening 90 for releasing steam from the useful space 100.

The functional element 50 and the drive shaft 60 are arranged in the useful space 100, and the connecting element 80 extends vertically through the second space 110.

Three recesses 120 are formed on the outer contour of the base component 70, as can be clearly seen in FIGS. 3 to 5. At each of the recesses 120, webs 125 are formed extending towards the connecting element and away from the useful space 100. In an inserted state, the recesses engage with projections 140 in the pot 30, whereby circumferential mounting of the insert module 20 is achievable. The projections 140 are formed by beads that extend in the longitudinal direction of the pot and serve as stabilization. In the inserted state, the webs 125 are supported on the projections 140, resulting in additional stabilization of the insert module 20 in the pot 30.

The base component opening 130 is arranged close to the drive shaft 60 of the functional element 50, so that as little as possible of the product to be processed can be driven upwardly from the useful space 100 through the base component opening 130 and into the third space 115. At the same time, the insert module 20 prevents the product to be processed from being pushed upwardly along the internal wall 37 of the pot by the functional element 50 while the product is being processed.

With regard to further advantageous configurations, reference is made to the general part of the description and to the appended claims in order to avoid repetition.

The exemplary embodiment shown in the figures is to be understood as being merely an example and can also be implemented differently.

1. An insert module for a pot of a kitchen appliance, the insert module comprising: a disk-shaped base component, wherein an outer diameter of the base component is adapted to an inner diameter of the pot, which inner diameter decreases towards a pot base of the pot in such a manner that the insert module rests inside the pot, spaced apart from the pot base at a working height, against an internal wall of the pot, wherein an outer contour of the base component is adapted to an inner contour of the internal wall at the working height, and wherein the insert module is designed to delimit a useful space within the pot towards the top in a state inserted into the pot.

2. The insert module according to claim 1, which additionally has a connecting means configured to delimit, in an inserted state, a third space from a second space formed between the base component and the internal wall, and wherein the connecting means is arranged perpendicular to the disk-shaped base component and/or is designed as a hollow cylinder.

3. The insert module according to claim 1, wherein a base component opening is formed in the base component, wherein the base component opening is arranged on a central axis through a center of the base component.

4. The insert module according to claim 2, wherein connecting means and base component opening are arranged relative to each other in such a manner that the base component opening forms a connection between the useful space and the third space.

5. The insert module according to claim 1, wherein the base component has a shaped portion, wherein the shaped portion is formed to be conical and/or funnel-shaped and/or, in an inserted state, is directed in the direction of the useful space.

6. The insert module according to claim 1, wherein at least one recess is formed on the outer contour of the base component, wherein the at least one recess is designed to engage, in the inserted state, with a projection formed on the internal wall of the pot.

7. The insert module according to claim 1, wherein at least one web is formed on the outer contour, wherein the at least one web projects from the base component in such a manner that in an inserted state, an outer edge of the web rests against the internal wall of the pot.

8. The insert module according to claim 6, wherein the at least one web is arranged at the at least one recess/one of the at least one recess.

9. The insert module according to claim 7, wherein the at least one web is at least partially lip-shaped and/or designed to seal off the useful space.

10. A kitchen appliance, comprising:
a pot having a pot base and an internal wall, wherein a useful space is formed inside the pot at the pot base, wherein the internal wall of the pot has an inner diameter and an inner contour in the circumferential direction, wherein the inner diameter decreases towards the pot base, and
an insert module according to claim 1, wherein the insert module can be inserted into an interior of the pot, wherein the insert module has a disk-shaped base component having an outer diameter and an outer contour, wherein the outer diameter is adapted to the inner diameter of the pot in such a manner that in an inserted state, the insert module rests inside the pot against the internal wall at a working height, wherein the outer contour of the base component is adapted to the inner contour of the pot at the working height, and wherein the insert module delimits the useful space towards the top.

11. The kitchen appliance according to claim 10, wherein a functional element is arranged or can be arranged in the useful space, which functional element is designed for processing the product located in the useful space and is configured to be driven by a drive unit of the kitchen appliance.

12. The kitchen appliance according to claim 10, wherein the kitchen appliance has a lid closing off the interior of the pot, and in that the insert module has a connecting element, wherein the connecting element is adapted to the lid and/or to the relative arrangement of the insert module to the lid in such a manner that the connecting element is supported on the lid.

13. The kitchen appliance according to claim 12, wherein a protrusion is formed on the lid and in that the connecting element engages with the protrusion or the protrusion engages with the connecting element.

14. The kitchen appliance according to claim 10, wherein in the inserted state, the insert module is arranged substantially parallel to the pot base.

15. A set including an insert module having a disk-shaped base component, wherein an outer diameter of the base component is adapted to an inner diameter of the pot, which inner diameter decreases towards a pot base of the pot in such a manner that the insert module rests inside the pot, spaced apart from the pot base at a working height, against an internal wall of the pot, wherein an outer contour of the base component is adapted to an inner contour of the internal wall at the working height, and wherein the insert module is designed to delimit a useful space within the pot towards the top in a state inserted into the pot and a pot for a kitchen appliance according to claim 10, wherein the insert module is adapted to an inner diameter and an inner contour of the pot.
